(19) United States
(12) Patent Application Publication
(10) Pub. No.: US 2011/0023696 A1
(43) Pub. Date: Feb. 3, 2011

(54) Apparatus for Absorbing Blast and Ballistic Energy and Method for Making Same

(76) Inventor: Fevzi Zeren, Ponte Vedra Beach, FL (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/817,848

(22) Filed: Jun. 17, 2010

Related U.S. Application Data
(60) Provisional application No. 61/213,911, filed on Jul. 28, 2009.

(51) Int. Cl. F41H 5/02; F41H 5/04; B23P 11/00

(52) U.S. Cl. 89/36.02; 29/428; 89/903; 89/904

(57) ABSTRACT

An armor system including a plurality of conduits each defining a respective hollow interior and a plurality of fiber bundles. Each of the plurality of conduits is substantially filled with a respective fiber bundle. A method of making armor including forming a plurality of fiber filled conduits, arranging a first group of the plurality of fiber filled conduits in a first layer having a first orientation, and arranging a second group of the plurality of fiber filled conduits in a second layer. The second orientation is different from the first orientation. A method of making a fiber filled conduit including forming a bundle of fibers and pulling the bundle of fibers through a hollow conduit such that the pulled bundle of fibers substantially fills the interior of the hollow conduit.

This application claims priority to U.S. Provisional Patent Application 61/213,911, which is hereby incorporated by reference.

### FIELD OF THE DISCLOSURE

The present disclosure relates to an apparatus for absorbing blast and ballistic energy (collectively “blast energy”). In particular, the present disclosure relates to an armor system for absorbing blast energy, a method of absorbing blast energy, a method of manufacturing an armor system from a plurality of fiber-filled conduits, and a method of manufacturing fiber-filled conduits.

### BACKGROUND

Conventional armor systems are subjected to various projectiles. Typically, the armor system is designed to defeat one or more types of the projectiles and usually includes a composite structure formed from one or more layers of different materials and/or of different structures. While most projectiles can be defeated by armor of sufficient strength and thickness, extra armor thickness is heavy, expensive, and adds weight to an armored vehicle using it. This added weight in turn places greater strain on the vehicle engine and drive train. Thus, there exists a need for an armor system that can defeat various projectiles without requiring excess weight of armor.

Some materials that potentially may be useful in armor systems are manufactured in fiber form that often present difficulties in fabricating bulk shapes other than woven material or planar sheets. Other methods of fabricating fiber reinforced components include pultrusion methods. Such methods conventionally include pulling continuous fibers, wetted with molten epoxy or resin, through a die to form a continuous extrusion having a desired cross section. Typical methods also include a curing step to solidify the epoxy or resin to form a solid extrusion that can be cut into desired lengths to form discrete structural members. These structural members thus have fibers directly embedded within the structural walls of the member. For example, conventional pultrusion methods may be used to form fiber reinforced composite pipe or hollow tubing as well as round, bar, or angle stock.

### SUMMARY

An aspect of the present disclosure is directed to an armor system. The armor system includes a plurality of interconnected conduits each defining a respective hollow interior and a plurality of fiber bundles. Each of the plurality of conduits is substantially filled with a respective fiber bundle.

Another aspect of the present disclosure is directed to a method of making armor. The method includes forming a plurality of fiber filled conduits. The method also includes arranging a first group of the plurality of fiber filled conduits in a first layer having a first orientation. The method also includes arranging a second group of the plurality of fiber filled conduits in a second layer. The second orientation is different from the first orientation.

Yet another aspect of the present disclosure is directed to a method of making a fiber filled conduit. The method includes forming a bundle of fibers and pulling the bundle of fibers through a hollow conduit such that the pulled bundle of fibers substantially fills the interior of the hollow conduit.

### BRIEF DESCRIPTION OF THE DRAWINGS

FIG. 1 is a flow chart diagram of an exemplary method of forming fiber filled conduits in accordance with an embodiment of the present disclosure;

FIG. 2 is a diagrammatic illustration of an apparatus for performing a step of the method of FIG. 1;

FIG. 3 is a diagrammatic illustration of an exemplary fiber bundle formed in accordance with a step of the method of FIG. 1;

FIG. 4 is a diagrammatic illustration of a plurality apparatus for performing a step of the method of FIG. 1;

FIG. 5 is a diagrammatic illustration of an exemplary fiber filled tube formed in accordance with a step of the method of FIG. 1;

FIG. 6 is a diagrammatic illustration of another pulling apparatus for performing a step of the method shown in FIG. 1;

FIG. 7 is a diagrammatic illustration of an exemplary arrangement of fiber filled tubes forming an armor system in accordance with a step of the method of FIG. 1; and

FIG. 8 is a diagrammatic illustration of an exemplary arrangement of plates having fiber filled holes forming an armor system in accordance with a step of the method of FIG. 1.

### DETAILED DESCRIPTION

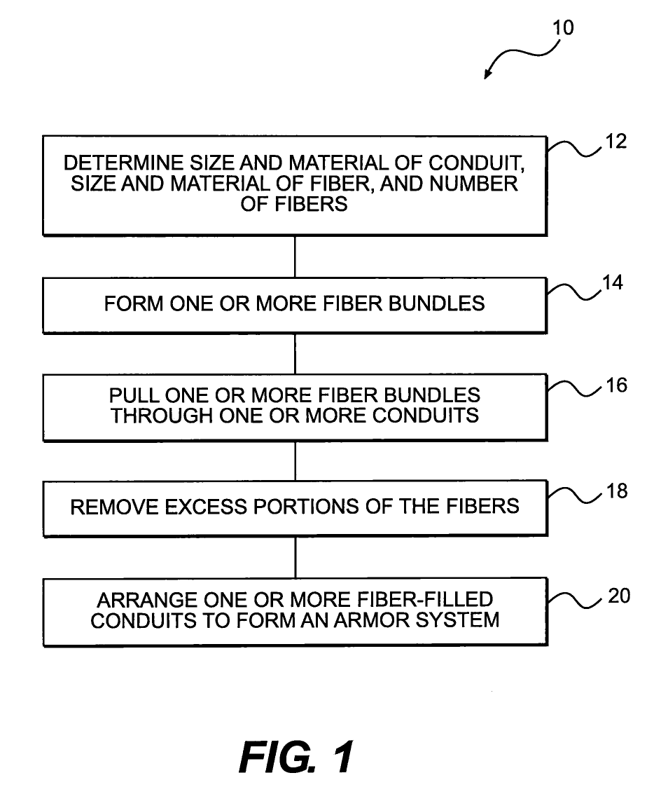

In accordance with one aspect of the disclosure, there is provided a method of making a fiber-filled conduit. FIG. 1 illustrates an exemplary method 10. Method 10 may include determining a desired size and material of the conduit, a desired size and material of the fibers, and determining the number of fibers desired for filling the conduit (step 12). Method 10 may also include forming one or more fiber bundles for filling the conduit (step 14). Method 10 may also include pulling the bundle through one or more conduits such that the fibers substantially fill the conduit (step 16). Selectively, method 10 may include removing the excess portions of the fibers that extend beyond the ends of the conduit (step 18) and may include forming an armor system having one or more of the fiber-filled conduits. As will be described in more detail below, method 10 may be configured to, in a first embodiment, form one or more discrete fiber filled tubes. Alternatively, in a second embodiment, method 10 may be configured to form one or more fiber filled holes that are respectively formed in a plate structure.

Step 12 may include determining a desired size of one or more conduits, a desired size of the fibers, and the desired number of fibers for substantially filling the conduit. Specifically, step 12 may include selecting desired conduits having desired dimensions, e.g., length, diameter, cross-sectional area or shape and wall thickness, and being made from desired materials. The conduit may be made from any known material including, for example, metal, e.g., aluminum or steel; ceramic; plastic, polymer; or composites. Additionally, step 12 may include selecting the desired size, e.g., diameter, and material of the fibers. The fibers may be metallic or non-metallic, braided or non-braided and may include any known type such as, for example glass fibers, ceramic fibers, carbon fibers, steel fibers, Tegris™, or Kevlar®. Additionally, two or more different sizes and/or types of fibers may be selected and combined with one another.

After the size of the conduit and fibers are selected, the desired number of fiber strands, i.e., individual fibers, to substantially fill the conduit may be determined. The desired number of fibers may be determined via any method. For example, the desired number of fibers may be determined based on the relative cross sectional area of the conduit and the relative cross sectional area of the respective fibers. It is contemplated that the number of fibers may include more or less than the actual number of fibers that may be accommodated within the conduit so as to provide a desired amount of compression of the fibers as well as a desired amount of frictional engagement between the fibers and with the interior surface of the conduit. It is also contemplated that substantially filling the conduit may include a suitable number of fibers so as to form an integral and effectively solid composite structural component. That is, a suitable number of fibers may be determined such that the fibers are, each in combination with the others, frictionally press-fit within the conduit.

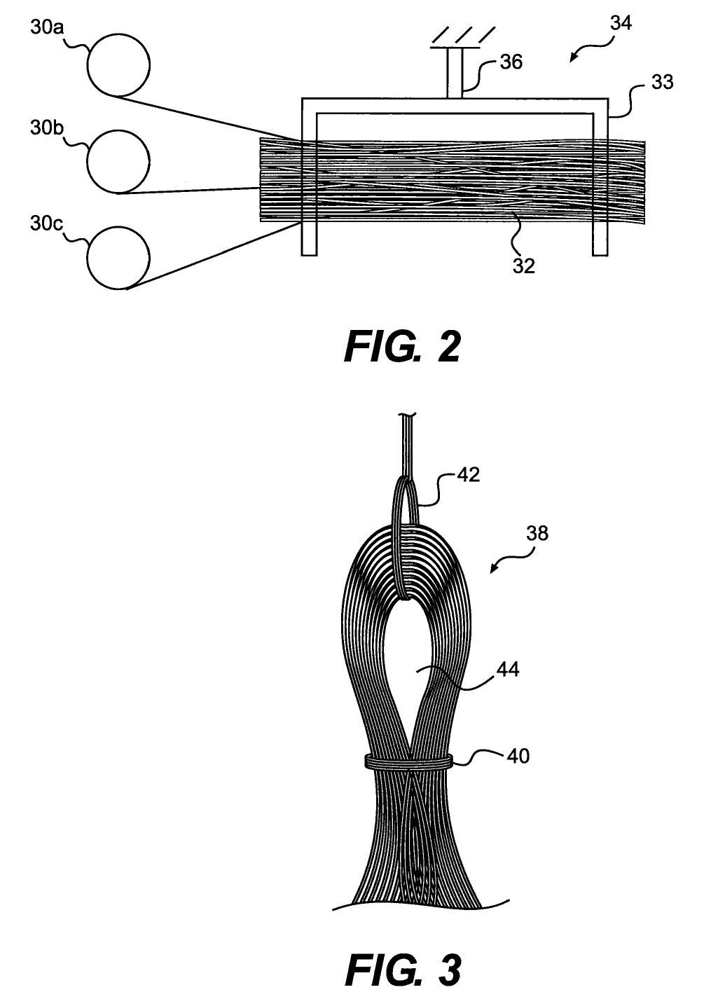

Step 14 may include forming a fiber bundle. Conventionally, stock fiber is formed as a continuous strand wound on a spool. Step 14 may include transferring the continuous stock fiber strand into a fiber bundle that includes a plurality of elongated fiber loops. Specifically, the plurality of fiber loops and, consequently, the fiber bundle, may include any diameter and length and may define a torroidal or elongated donut-shaped bundle of fiber. For example, as shown in FIG. 2, step 14 may include transferring fiber from one or more fiber spools 30a, 30b, 30c into a fiber bundle 32. Fiber bundle 32 may include a plurality of elongated fiber loops assembled around a suitable jig apparatus 34. The jig apparatus may include an elongated U-shaped bar structure 33 configured to rotate about a pivot point 36. Such that as the elongated U-shaped bar structure 33 rotates, fiber strands are transferred from the fiber spools 30a, 30b, 30c to the jig apparatus 34. FIG. 2 illustrates three fiber spools 30a, 30b, 30c, however, it is contemplated that step 14 may include substantially simultaneously transferring fiber from more or less than three fiber spools. It is also contemplated that step 14 may include substantially simultaneously transferring one or more different types and/or different size fibers onto jig apparatus 34.

After a desired number of elongated fiber loops are transferred, the fiber bundle 32 may be removed from the jig apparatus 34 and folded into a U-shaped bundle. FIG. 3 illustrates an exemplary U-shaped fiber bundle 38. U-shaped bundle 38 may be bound together with a binding strap 40. Binding strap 40 may include any suitable type of strap configured to maintain the shape of U-shaped fiber bundle 38. For example, binding strap 40 may include a tie-wrap or other suitable band and may be made from any suitable material. It is contemplated that binding strap 40 may be removed from U-shaped bundle 38 before it is pulled through a conduit as described in more detail below. As such, binding strap 40 may be configured to temporarily maintain the shape of U-shaped bundle 38.

U-shaped bundle 38 may also include a pulling strap 42 secured around the folded end of U-shaped bundle 38 and configured to transfer a pulling force thereto. Specifically, pulling strap 42 may be secured to U-shaped bundle 38 through a hole 44 formed at the folded end of the bundle. It is contemplated that pulling strap 42 may be made from any suitable material and may have sufficient tensile strength so as to withstand and transfer a pulling force to U-shaped bundle 38.

Step 16 may include pulling U-shaped bundle 38 through a conduit such that the fibers substantially fill the conduit. It is contemplated that step 16 may include pulling a wet bundle, i.e., a bundle wetted with resin or other curable component, or a dry bundle, i.e., a non-wetted bundle through a conduit. U-shaped bundle 38 may be disposed adjacent one end of the conduit such that the associated pulling strap 42 extends through the conduit (see FIG. 4). U-shaped bundle 38 may be pulled through the conduit by applying a pulling force, sufficient in overcoming the frictional of the fibers with the interior surface of the conduit in the direction of arrow A (FIG. 4), to pulling strap 42. Step 16 may also include applying sufficient force to pull the U-shaped bundle 38 completely through the conduit so that it extends beyond both ends of the conduit. As such, the U-shaped bundle 38 may be “press-fit” therein. It is contemplated that U-shaped bundle 38 may be pulled through the conduit until the portion of the pulling strap 42 that surrounds the U-shaped bundle exits the conduit. As such, the U-shaped bundle may extend beyond both ends of the conduit and each of the individual fibers thereof may be substantially aligned with one another as well as with the longitudinal axis of the conduit forming a substantially solid fiber-filled conduit. It is also contemplated that U-shaped bundle 38 may be pulled in a substantially straight direction to substantially align the individual fibers with the longitudinal axis of the conduit or may be pulled in a rotating direction to create a spiral wound bundle. It is contemplated that the number of twists for a rotated bundle may be a function of the frictional interaction between the bundle and the interior surface of the conduit.

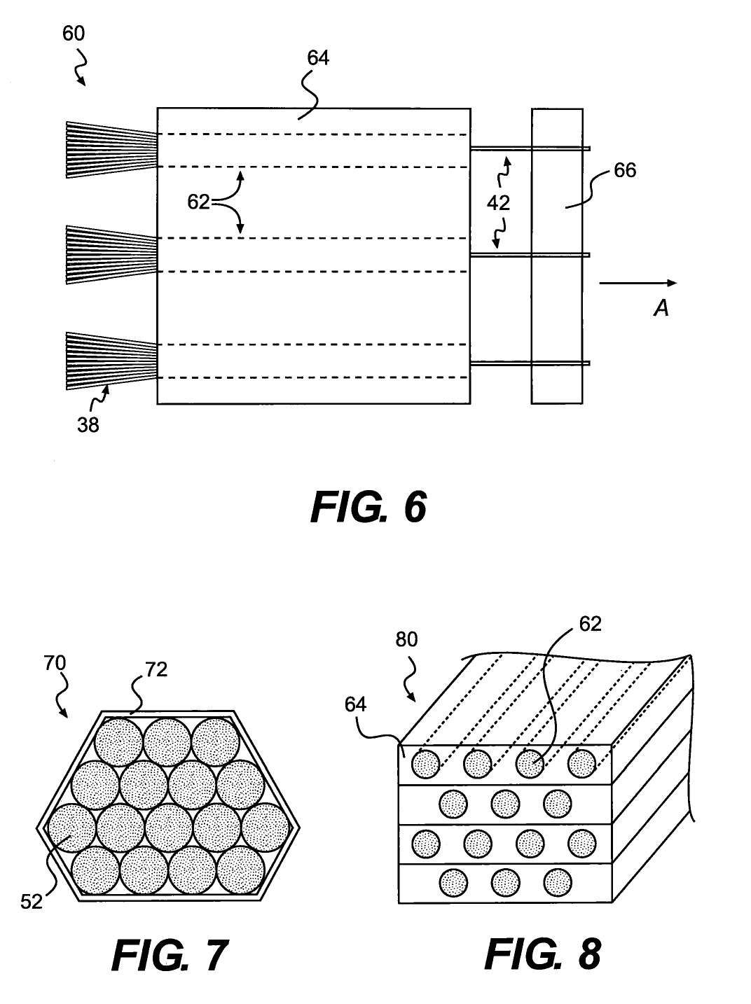

FIG. 4 illustrates an exemplary embodiment of a pulling apparatus 50 for pulling U-shaped bundle 38 through a conduit embodied as a hollow tube 52. As discussed below with respect to FIG. 6, the hollow conduit may, alternatively, be embodied as one of a plurality of holes formed within a structural plate element. Although illustrated herein as a substantially cylindrical conduit, e.g., hollow tube 52, it is contemplated that the conduit may include any cross-sectional shape, e.g., circular polygonal or ovular.

Pulling apparatus 50 may include a funnel element 54 having a tapered inner diameter. Funnel element 54 may be disposed at one end of the hollow tube and may be configured to sequentially reduce, i.e., compress, the diameter, of U-shaped bundle 38 as it is pulled through therethrough. Funnel element 54 may include a clam-shell or other clampable fixture that attaches about an outer end of hollow tube 52. It is contemplated that funnel element 54 may include one or more step portions configured to accommodate the thickness of the hollow tube so as to form a smooth transition from its inner tapered surface to the inner surface of the hollow tube.

Pulling apparatus 50 may also include one or more devices (not shown) configured to apply a pulling force, in the direction of arrow A, to pulling strap 42 and, correspondingly, U-shaped bundle 38. Such devices may include any conventional apparatus configured to apply sufficient force to the U-shaped bundle 38 to overcome the frictional resistance with the interior surfaces of the funnel element 54 and hollow tube 52 so as to pull U-shaped bundle 38 into a substantially press-fit engagement within hollow tube 52. In an exemplary embodiment, the resulting packing density of U-shaped bundle 38 may be as high as 85% of the solid, or absolute, material density of fibers forming U-shaped bundle 38. It is contemplated that a suitable device may include a shop press or hydraulic lifter with or without a pressure gauge to indicate the magnitude of the pulling force.

FIG. 6 illustrates another exemplary embodiment of a pulling apparatus 60 with respect to a plurality of holes 62 embodied as a plurality of conduits. The plurality of holes 62 may be formed in a structural plate element 64. As discussed above with respect to FIG. 4, the hollow conduit may, alternatively, be embodied as hollow tube 52. Pulling apparatus 60 may include a head element 66 configured to connect to one or more pulling straps 42 associated with one or more U-shaped bundle 38. Head element 66 may include a bar or other elongated stock element having sufficient structural strength to transfer a pulling force from one or more pulling devices (not shown) to pulling straps 42 and, correspondingly, to U-shaped bundles 38. As described above, the pulling apparatus may include any conventional apparatus. It is contemplated that a suitable device may include a shop press or hydraulic lifter with or without a pressure gauge to indicate the magnitude of the pulling force, and may be configured to apply a pulling force to head element 66 in the direction of arrow A. As shown in FIG. 6, pulling apparatus 60 may be configured to substantially simultaneously pull a plurality of U-shaped bundles 38 through respective holes 62. It is contemplated that pulling apparatus 60 may further include one or more funnel elements (not shown), similar to funnel element 54 described above, disposed at a respective ends of the plurality of holes 62 and configured to sequentially reduce, i.e., compress, the diameter, of U-shaped bundle 38 as it is pulled through therethrough. It is also contemplated that the one or more funnels associated with pulling apparatus 60 may be configured to attach to plate 64 via any conventional connection such as, for example, a bolted connection, a clamped connection, or a press-fit connection.

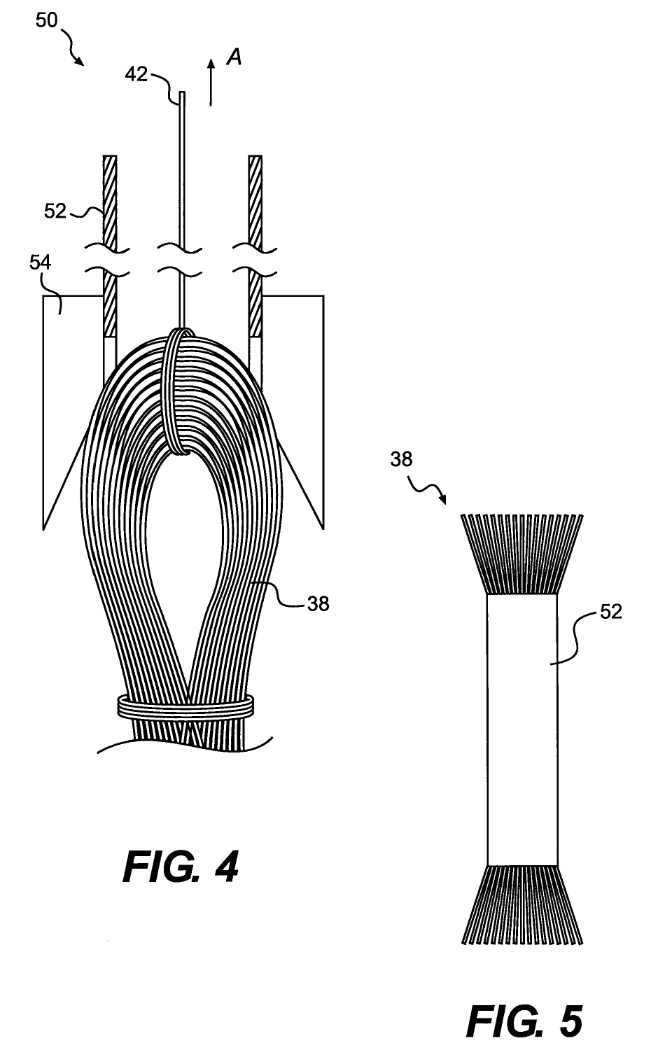

Step 18 may include removing the excess portions of the fibers that extend beyond the ends of a fiber-filled conduit. For example, step 18 may include removing substantially all of the excess fibers that extend beyond the end of hollow tube 52 (see FIG. 5) or that extend beyond the end of plate 62 (see FIG. 6). As such each of the individual fiber strands, pulled-through a respective conduit, may be substantially aligned with the axis of, and approximately the same length as, the conduit. Step 18 may optionally include immersing a fiber-filled conduit, e.g., a fiber-filled tube 52 or a fiber-filled hole 62, in a liquid such as, for example, water. It is contemplated that doing so may permit the liquid to fill void spaces between individual fiber strands within the fiber-filled tube 52 or within the fiber-filled hole 62. In a non-limiting example, one embodiment may include immersing a fiber-filled conduit, i.e., a dry fiber-filled conduit, until the fibers become completely saturated and the void spaces are substantially full, e.g., for approximately two (2) hours. If a high viscosity liquid is used, immersion may not be sufficient to fill the void spaces. Therefore, if a high viscosity liquid is used, a pumping source (not shown) may be used to pump the liquid into the void spaces. In this manner it is contemplated that immersion, pumping, or a combination of immersion and pumping may be used to fill the void spaces with any chosen liquid. It is further contemplated that resins or flowable epoxy may be used to fill the void space. In this example, the resin or epoxy may form a composite with the fiber.

It is also contemplated that when a fiber-filled conduit is immersed in a liquid to permit the liquid to fill void spaces, the ends of the fiber-filled conduit may be encapsulated and sealed to prevent evaporation of the liquid. In a non-limiting example, a first end of the immersed fiber-filled tube 52 may be raised above the surface of the liquid and may have epoxy or resin applied to the end. Next the fiber filed tube 52 may be re-immersed and rotated within the liquid and the process may be repeated for the second end. It is further contemplated that one of the first or the second ends may be sealed prior to the addition of any liquid, and that any other sealing method known in the art, such as, for example, a semi-soft impermeable flexible cover, may be used. It is also contemplated that the sealing methods used for the first end and the second end may be different.

Step 20 may include arranging a plurality of the fiber-filled conduits to form an armor system. Specifically, step 20 may include arranging one or more fiber-filled tubes 52 and/or one or more plates 64 having a plurality of fiber-filled holes 62 with respect to one another to form the armor system. For example, FIG. 7 illustrates an exemplary armor system embodiment that includes a plurality of fiber-filled tubes 52 arranged in a stacked relationship of adjacent rows, wherein a fiber-filled tube 52 in one row is off-set and positioned between two fiber-filled tubes 52 of an adjacent row. Additionally, FIG. 8 illustrates another exemplary armor embodiment that includes a plurality of plates 64 having fiber-filled holes 62 therein arranged in a stacked relationship of adjacent rows, wherein a fiber-filled hole 62 in one row is off-set and positioned between two fiber-filled holes 62 of an adjacent row. It is contemplated that step 20 may include arranging any number of fiber-filled conduits in any arrangement to form an armor system. For example, step 20 may include arranging fiber-filled conduits in alternating, criss-crossing, or off-set arrangement according to any patterned relationship. It is also contemplated that step 20 may include forming an armor system consisting essentially of only interconnected fiber-filled conduits, e.g., fiber-filled tubes 52 or fiber-filled holes 62, or forming armor comprising both fiber-filled conduits and conventional armor or armor system components. It is further contemplated that step 20 may include forming an armor system including one or more fiber-filled conduits that have been immersed in a liquid to permit the liquid to fill voids formed between individual fiber strands, i.e., “wet” fiber-filled conduits, and including one or more fiber-filled conduits that have not been immersed in a liquid, i.e., “dry” fiber-filled conduits.

It will be apparent to those skilled in the art that various modifications and variations can be made to the disclosed method and apparatus. Other embodiments will be apparent to those skilled in the art from consideration of the specification and practice of the disclosed method and apparatus. It is intended that the specification and examples be considered as exemplary only, with a true scope being indicated by the following claims and their equivalents.

What is claimed is:

1. An armor system, comprising:
a plurality of interconnected conduits each defining a respective hollow interior; and
a plurality of fiber bundles;
wherein each of the plurality of conduits is substantially filled with a respective fiber bundle.

2. The armor system of claim 1, wherein the plurality of conduits are a plurality of tubes, the armor system further including:
a first armor layer formed from a plurality of tubes arranged in a first orientation; and
a second armor layer formed from a plurality of metal tubes arranged in a second orientation different than the first orientation.

3. The armor system of claim 1, wherein the plurality of conduits are a plurality of holes formed in a plate.

4. The armor system of claim 1, wherein each of the plurality of fiber bundles is press-fit within a respective conduit forming a plurality of fiber-filled conduits.

5. The armor system of claim 4, wherein at least one of the plurality of the fiber-filled conduits is immersed in a liquid to substantially fill voids between individual fiber strands with the liquid.

6. The armor system of claim 5, wherein the at least one of the fiber-filled conduits in encapsulated.

7. A method of making armor, comprising:
forming a plurality of fiber-filled conduits;
arranging a first group of the plurality of fiber filled conduits in a first layer having a first orientation; and
arranging a second group of the plurality of fiber filled conduits in a second layer having a second orientation different from the first orientation.

8. The method of claim 7, wherein forming the plurality of fiber-filled conduits includes respectively pulling a plurality of fiber bundles through a plurality of associated tubes to form a plurality of discrete fiber filled tubes.

9. The method of claim 7, wherein forming the plurality of fiber filled conduits includes respectively pulling a plurality of fiber bundles through a plurality of holes formed in a plate to form a plurality of interconnected fiber filled tubes.

10. The method of claim 7, wherein forming a plurality of fiber-filled conduits includes respectively pulling a plurality of fiber bundles through a plurality of hollow conduits so as to press-fit the fiber bundle within the hollow conduit.

11. The method of claim 10, wherein forming a plurality of fiber-filled conduits includes immersing a fiber-filled conduit within a liquid to permit the liquid to fill voids between individual fiber strands.

12. The method of claim 11, further including encapsulating the fiber filled conduit.

13. A method of making a fiber filled conduit, comprising:
forming a bundle of fibers; and
pulling the bundle of fibers through a hollow conduit such that the pulled bundle of fibers substantially fills the interior of the hollow conduit.

14. The method of claim 13, wherein the hollow conduit is a cylindrical tube.

15. The method of claim 13, wherein:
forming a bundle of fibers includes forming a plurality of bundles of fibers;
pulling the bundle of fibers includes pulling each of the plurality of bundles of fibers through respective ones of a plurality of hollow conduits such that each pulled bundle of fibers substantially fills the interior of an associated hollow conduit.

16. The method of claim 15, wherein each of the plurality of hollow conduits is a hole formed in a single plate.

17. The method of claim 13, wherein forming the bundle of fibers includes forming a dry bundle of fibers and pulling the bundle of fibers includes pulling the dry bundle of fibers.

18. The method of claim 13, wherein pulling the bundle of fibers includes pulling the bundle of fibers through the hollow conduit such that the pulled bundle of fibers is substantially press-fit within the interior of the hollow conduit.

19. The method of claim 13, wherein pulling the bundle of fibers includes pulling the bundle of fibers through the hollow conduit such that the fibers of the pulled bundle of fibers are substantially aligned with the longitudinal axis of the conduit.

20. The method of claim 13, wherein pulling the bundle of fibers includes pulling the bundle of fibers through the hollow conduit such that the fibers of the pulled bundle of fibers are substantially twisted with respect to the longitudinal axis of the conduit.

21. The method of claim 13, wherein pulling the bundle of fibers includes substantially simultaneously rotating the bundle of fibers while pulling the bundle of fibers through the hollow conduit.

22. The method of claim 15, wherein pulling the bundle of fibers through the hollow conduit forms a fiber-filled conduit, the method further including immersing the fiber filled conduit in a liquid.
